(19) United States
(12) Patent Application Publication
(10) Pub. No.: US 2007/0180231 A1
(43) Pub. Date: Aug. 2, 2007

(54) Preventing entitlement management message (EMM) filter attacks

(75) Inventors: Glenn A. Morten, Bellevue, WA (US); Edward C. Hiar, Lynnwood, WA (US)

Correspondence Address: DARBY & DARBY P.C., P.O. BOX 770, Church Street Station, New York, NY, 10008-0770, US

(73) Assignee: Widevine Technologies, Inc., Seattle, WA (US)

(21) Appl. No.: 11/344,321

(22) Filed: Jan. 31, 2006

(51) Int. Cl. H04L 9/00

(52) U.S. Cl. 713/158

(57) ABSTRACT

A system, apparatus, and method are directed towards preventing entitlement/rights filter attacks in a conditional access to secure content over a network. An EMM that is configured to revoke access to selected content may be sent to a user, when a content provider, or the like, determines that access to the selected content is to be revoked for that user. A server may monitor for an acknowledgment of the revocation. If, after a predetermined time, a valid acknowledgement is not received by the server, the server may send another revocation EMM and again monitor for an acknowledgement response. If, after a predetermined number of retry attempts, a valid acknowledgement is not received, the server may send an alert message, investigate for possible network or device failures, change of encryption keys such as the CW, change a service key, or the like, for future content delivery to the user.

### BACKGROUND OF THE INVENTION

The present invention relates generally to digital copy protection, digital right management, and conditional access, and more particularly but not exclusively to managing revocation of an entitlement or right to access a file by preventing Entitlement Management Message (EMM) filter attacks.

Recent advances in the telecommunications and electronics industry, and, in particular, improvements in digital compression techniques, networking, and hard drive capacities have led to growth in new digital services to a user's home. For example, such advances have provided hundreds of cable television channels to users by compressing digital data and digital video, transmitting the compressed digital signals over conventional coaxial cable television channels, and then decompressing the signals in the user's receiver. One application for these technologies that has received considerable attention recently includes video-on-demand (VOD) systems where a user may communicate with a service operator to request media content and the requested content is routed to the user's home for enjoyment. The service operator typically obtains the content from an upstream content provider, such as a content owner, distributor, or the like.

To protect content from unauthorized use, service operators, content providers, owners, and so forth, may employ a service known as conditional access or digital rights management. Conditional access or digital rights management enables a provider to restrict access of selected content to selected users. This may be achieved, for example by encrypting the content.

One such encryption approach employs a technique that provides a message known as an Entitlement Control Message (ECM). The ECM is typically a packet which includes information to determine a control word (CW) for use in decrypting the content. In this approach, streaming content may be encrypted using the CW. The CW may be encrypted with a service key via the ECM message. The encrypted content, including the ECM may then be provided to a user.

The service key may also be encrypted using an encryption key that may be specific to a user, and sent to the user within a message frame, packet, or the like. For example, the service key may be sent within an Entitlement Management Message (EMM). The EMM may also include additional information such as subscription information, or the like, associated with a user. For example, the EMM may include information that indicates whether the user has a right to access the decrypted content, possible constraints upon the access, or whether such access right is revoked.

However, if an EMM that revokes a right to access the content is not properly received, typically by a content player device, the user may continue to improperly access the content. Failure to receive the revocation EMN revoking access rights may arise for a variety of reasons. For example, a less than scrupulous user may select to employ an EMM filtering mechanism that prevents their content player device from receiving the revocation EMM. In such instances, the user may continue inappropriately to access content. Therefore, it is with respect to these considerations and others that the present invention has been made.

### BRIEF DESCRIPTION OF THE DRAWINGS

Non-limiting and non-exhaustive embodiments of the present invention are described with reference to the following drawings. In the drawings, like reference numerals refer to like parts throughout the various figures unless otherwise specified.

For a better understanding of the present invention, reference will be made to the following Detailed Description of the Invention, which is to be read in association with the accompanying drawings, wherein:

FIG. 1 shows a functional block diagram illustrating one embodiment of an environment for practicing the invention;

FIG. 2 shows one embodiment of a network device that may be included in a system implementing the invention;

FIG. 3 shows on embodiment of a data signal flow usable in preventing entitlement/rights filter attacks over a network; and FIG. 4 illustrates a message flow diagram generally showing one embodiment of a flow of signals for preventing entitlement/filter filter attacks in a conditional access to secure content over a network, in accordance with the present invention.

### DETAILED DESCRIPTION OF THE INVENTION

The present invention now will be described more fully hereinafter with reference to the accompanying drawings, which form a part hereof, and which show, by way of illustration, specific exemplary embodiments by which the invention may be practiced. This invention may, however, be embodied in many different forms and should not be construed as limited to the embodiments set forth herein; rather, these embodiments are provided so that this disclosure will be thorough and complete, and will fully convey the scope of the invention to those skilled in the art. Among other things, the present invention may be embodied as methods or devices. Accordingly, the present invention may take the form of an entirely hardware embodiment, an entirely software embodiment or an embodiment combining software and hardware aspects. The following detailed description is, therefore, not to be taken in a limiting sense.

Throughout the specification and claims, the following terms take the meanings explicitly associated herein, unless the context clearly dictates otherwise. The phrase “in one embodiment” as used herein does not necessarily refer to the same embodiment, though it may. As used herein, the term “or” is an inclusive “or” operator, and is equivalent to the term “and/or,” unless the context clearly dictates otherwise. The term “based on” is not exclusive and allows for being based on additional factors not described, unless the context clearly dictates otherwise. In addition, throughout the specification, the meaning of “a,” “an,” and “the” include plural references. The meaning of “in” includes “in” and “on.”

Briefly stated, the present invention is directed towards a system, apparatus, and method for preventing entitlement (EMM) filter attacks in a conditional access to secure content over a network. An EMM that is configured to revoke access to selected content may be sent to a user, when a content provider, or the like, determines that access to the selected content is to be revoked for that user. In one embodiment, the revocation EMM may be sent over a network to the user's content player from a server. The server may then monitor for an acknowledgment of the revocation from the content player. In one embodiment, the acknowledgment may include a message, such as a nonce, or the like, to ensure that the content player was not spoofed. In another embodiment, the acknowledgement may be digitally signed by a component associated with the content player, or the like. If, after a predetermined time period, a valid acknowledgement is not received by the server, the server may initiate a retry attempt. The retry attempt may include sending another revocation EMM and again monitoring for an acknowledgement response from the content player. If, after a predetermined number of retry attempts, a valid acknowledgement is not received, the server may perform various revocation failure actions. Such revocation failure actions may include sending an alert message, changing of encryption keys such as the CW, the service key, or the like, for future content delivery to limit the usefulness of existing keys delivered to the user. In one embodiment, the revocation failure action may also include determining whether a network, content player, or the like, associated with the user is failed. For example, a possible reason for failure to receive the acknowledgement may be associated with a network failure between the server and the user. Thus, in one embodiment, the invention may also be employed provide an alert regarding possible network and/or device failures.

Although the invention is described in terms of EMM attacks, the invention is not so limited, and attacks upon other revocation message mechanisms may also be prevented using the present invention, without departing from the scope or spirit of the invention. For example, an Access Control List (ACL) may be employed to invalidate access to the content. In one embodiment, the ACL may be used to invalidate a digital certificate, or the like. The present invention may then be configured to provided the ACL to the client device, or the like, and monitor for possible ACL filtering, by monitoring for an acknowledgement message.

Illustrative Environment

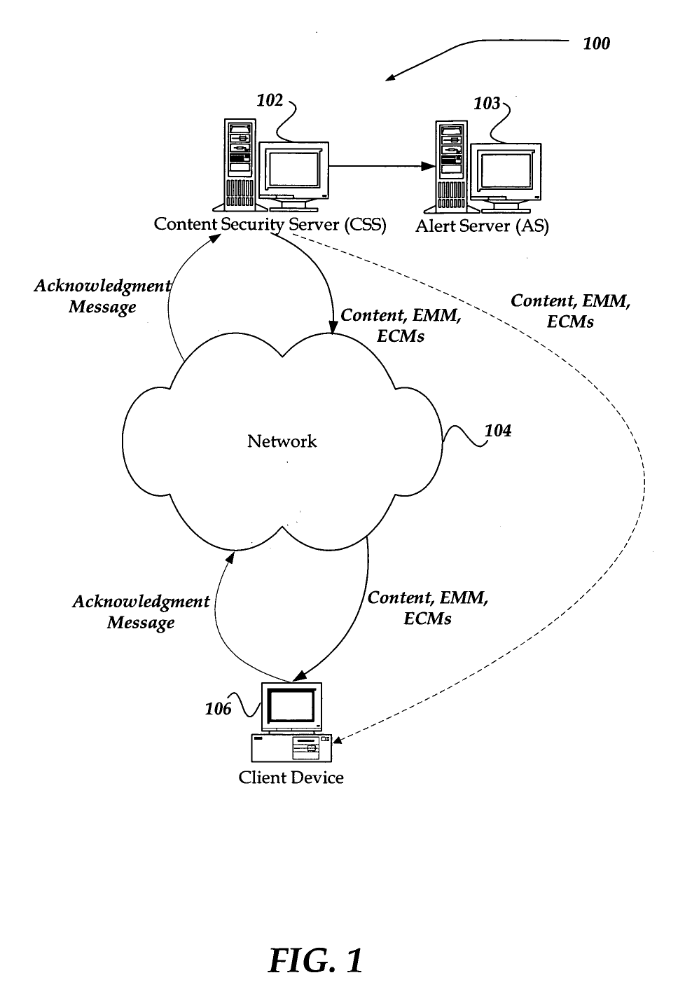

FIG. 1 shows a functional block diagram illustrating one embodiment of operating environment 100 in which the invention may be implemented. Operating environment 100 is only one example of a suitable operating environment and is not intended to suggest any limitation as to the scope of use or functionality of the present invention. Thus, other well-known environments and configurations may be employed without departing from the scope or spirit of the present invention.

As shown in the figure, operating environment 100 includes Content Security Server (CSS) 102, Alert Server (AS) 103, network 104, and client device 106. Network 104 is in communications with and enables communication between CSS 102 and client device 106. CSS 102 is also in communication with AS 103.

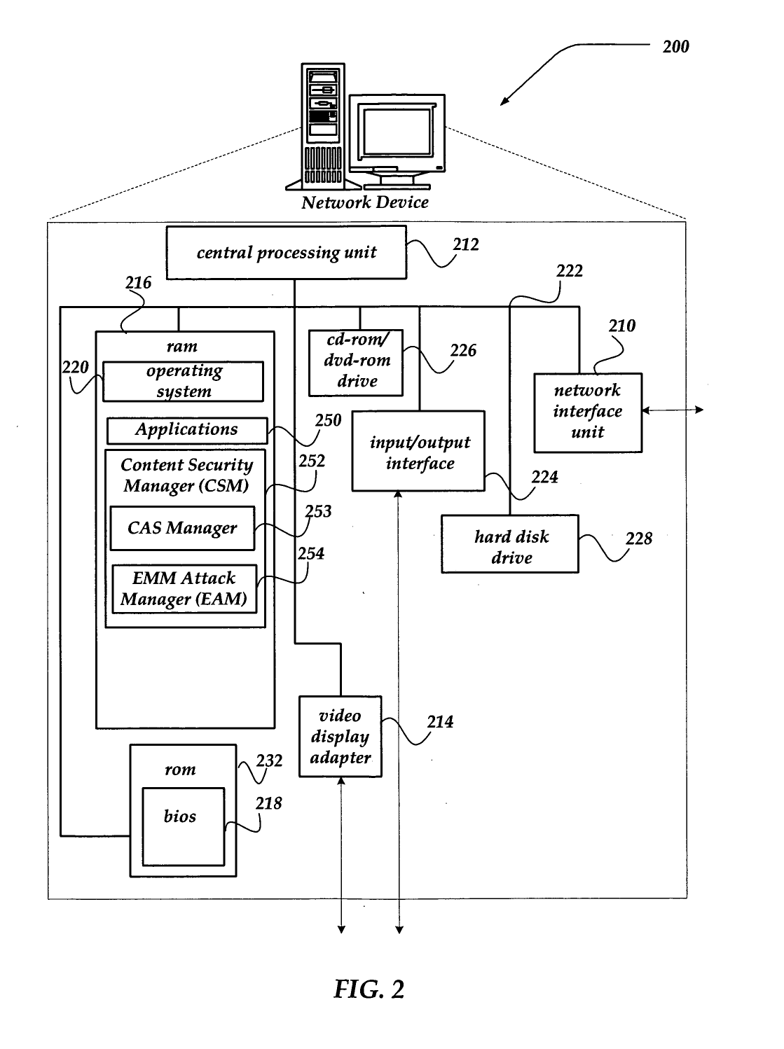

One embodiment of CSS 102 is described in more detail below in conjunction with FIG. 2. Briefly, however, CSS 102 includes virtually any network device configured for use by producers, developers, and/or owners of media content that can be distributed to client device 106. Such content, includes, but is not limited to motion pictures, movies, videos, music, PPV, VoD, interactive media, audios, still images, text, graphics, and other forms of digital content directed towards a user of a client device, such as client device 106, or the like. CSS 102 may also include businesses, systems, or the like that obtain rights from a content owner to copy and distribute the content. CSS 102 may obtain the rights to copy and distribute from one or more content owners. CSS 102 may repackage, store, and schedule content for subsequent sale, distribution, and license to other content providers, users of client device 106, or the like.

CSS 102 may provide the content over network 104 to client device 106, or the like. CSS 102 may provide the content using any of a variety of mechanisms. In one embodiment, the content is provided as a Moving Pictures Experts Group (MPEG) content stream, such as a transport stream, or the like. However, the invention is not so limited, and other file formats may also be employed, without departing from the scope or spirit of the invention.

Briefly, MPEG is an encoding and compression standard for digital broadcast content. MPEG provides compression support for television quality transmission of video broadcast content. Moreover, MPEG provides for compressed audio, control, and even user broadcast content. One embodiment of MPEG-2 standards is described in ISO/IEC 13818-7 (available at http://www.iso.org), which is hereby incorporated by reference.

Briefly, MPEG content streams may include Packetized Elementary Streams (PES), which typically include fixed (or variable sized) blocks or frames of an integral number of elementary streams (ES) access units. An ES typically is a basic component of an MPEG content stream, and includes digital control data, digital audio, digital video, and other digital content (synchronous or asynchronous). A group of tightly coupled PES packets referenced to substantially the same time base comprises an MPEG program stream (PS). Each PES packet also may be broken into fixed-sized transport packet known as MPEG Transport Streams (TS) that form a general-purpose approach of combining one or more content streams, possible including independent time bases. Moreover, MPEG frames may include intra-frames (I-frames), forward predicted frames (P-frames), and/or bidirectional predicted frames (B-frames).

CSS 102 may also enable scrambling and/or encryption of the content to minimize the likelihood that non-subscribers from enjoying the content. CSS 102 may also manage access control messages to determine whether descrambling and/or decrypting of the content is to be performed. In one embodiment, CSS 102 may employ ECM and/or EMM messages to manage conditional access to the scrambled content. However, the invention is not so limited, and other forms of access control messages, or mechanisms, may also be employed without departing from the scope or spirit of the invention.

CSS 102 may provide access control messages that either enable access to content, or restricts access of content. For example, in one embodiment, CSS 102 may provide an access control message, such as a revocation EMM, or the like, that removes access rights to particular content. In one embodiment, the revocation EMM may include a message indicating that an entitlement or right to access particular content is revoked for the client. CSS 102 may also be configured to monitor for a message from the client indicating acknowledgement of the revocation EMM. Failure to receive the acknowledgement message within a predetermined period of time may result in CSS 102 performing a retry attempt and/or a revocation failure action, as described in more detail below. In one embodiment, the revocation failure action may include providing a message to AS 103.

AS 103 includes virtually any network device that may be configured to monitor for revocation failure alert messages and perform a revocation failure action. AS 103 may receive the revocation failure alert message using a variety of mechanisms including an email message, a Simple Network Management Protocol (SNMP) message, a Common Management Information Protocol (CMIP) signal, or the like.

AS 103 may perform a variety of actions based on receipt of the revocation failure alert message. For example, in one embodiment, AS 103 may provide a message, alert, or the like, indicating that inspection of a network and/or network device may be warranted. The inspection may be directed to determining whether a failure to receive an acknowledgement message is associated with a network failure, device failure, or the like. In another embodiment, AS 103 may direct CSS 102, or the like, to change scrambling/encryption keys, and/or service keys associated with the content for the client device, subscriber, or the like.

AS 103 may further store the revocation failure alert message in a data store, such as a Forensic data store, or the like. AS 103, and/or another device (not shown) may then employ the stored message for a variety of actions, including, but not limited to performing trend analysis, or the like; enabling legal actions to commence based at least in part on the stored message; enabling diagnosis of a network or other communications path to enable such activities as optimization of network reliability; or the like.

Devices that may operate as CSS 102 and/or AS 103 include personal computers, desktop computers, multiprocessor systems, network appliance, microprocessor-based or programmable consumer electronics, network PCs, servers, or the like.

Although CSS 102 and AS 103 are illustrated as distinct servers, the invention is not so limited. For example, the functionality of CSS 102 and AS 103 may also be implemented within a single network device, or distributed over more than two network devices.

Network 104 is configured to couple one computing device to another computing device to enable them to communicate. Network 104 is enabled to employ any form of computer readable media for communicating information from one electronic device to another. Also, network 104 may include a wireless interface, and/or a wired interface, such as the Internet, in addition to local area networks (LANs), wide area networks (WANs), direct connections, such as through a universal serial bus (USB) port, other forms of computer-readable media, or any combination thereof. On an interconnected set of LANs, including those based on differing architectures and protocols, a router acts as a link between LANs, enabling messages to be sent from one to another. Also, communication links within LANs typically include twisted wire pair or coaxial cable, while communication links between networks may utilize analog telephone lines, full or fractional dedicated digital lines including T1, T2, T3, and T4, Integrated Services Digital Networks (ISDNs), Digital Subscriber Lines (DSLs), wireless links including satellite links, or other communications links known to those skilled in the art. Furthermore, remote computers and other related electronic devices could be remotely connected to either LANs or WANs via a modem and temporary telephone link. In essence, network 104 includes any communication method by which information may travel between client devices 106 and/or CSS 102.

Moreover, network 104 may represent a plurality of different components, and/or network paths between CSS 102 and client device 106. Thus, content and/or other information provided by CSS 102 to client device 106 may employ at least in part a different network component and/or path than information provided by client device 106 to CSS 102. For example, CSS 102 may provide content, including ECMs, and/or EMMs to client device 106 over a satellite link, while client device 106 may provide information to CSS 102 using a wired link, a telephone dial-up component, or the like. However, the invention is not so limited, and CSS 102 and client device 106 may also employ virtually the same network 104 components, protocols, and/or mechanisms with which to communicate information, and/or a variety of other paths, components, or the like.

CSS 102 is not limited to providing content, and/or ECMs, and/or EMMs to client device 106 over network 104, however. For example, CSS 102 may also employ a variety of other portable content storage devices, including, but not limited to Digital Versatile Discs (DVDs), High Definition DVD (HD-DVD), Compact Discs (CDs), Video Compact Disc (VCD), Super VCD (SVCD), Super Audio CD (SACD), Dynamic Digital Sound (DDS) content media, Read/Write DVD, CD-Recordable (CD-R), Blu-Ray discs, or the like. Moreover, CSS 102 may provide content using, for example, a portable content storage device, while providing the ECMs, ENMs, including, possibly a revocation EMM, over network 104, without departing from the scope or spirit of the invention.

The media used to transmit information in communication links as described above illustrates one type of computer-readable media, namely communication media. Generally, computer-readable media includes any media that can be accessed by a computing device. Computer-readable media may include computer storage media, communication media, or any combination thereof.

Additionally, communication media typically embodies computer-readable instructions, data structures, program modules, or other data in a modulated data signal such as a carrier wave, data signal, or other transport mechanism and includes any information delivery media. The terms “modulated data signal,” and “carrier-wave signal” includes a signal that has one or more of its characteristics set or changed in such a manner as to encode information, instructions, data, or the like, in the signal. By way of example, communication media includes wired media such as twisted pair, coaxial cable, fiber optics, wave guides, and other wired media and wireless media such as acoustic, RF, infrared, and other wireless media.

Client device 106 may include virtually any computing device capable of receiving content over a network, such as network 104, from another computing device, such as CSS 102. Client device 106 may also include any computing device capable of receiving the content employing other mechanisms, including, but not limited to CDs, DVDs, tape, electronic memory devices, or the like. The set of such devices may include devices that typically connect using a wired communications medium such as personal computers, multiprocessor systems, microprocessor-based or programmable consumer electronics, network PCs, or the like. The set of such devices may also include devices that typically connect using a wireless communications medium such as cell phones, smart phones, pagers, walkie talkies, radio frequency (RF) devices, infrared (IR) devices, CBs, integrated devices combining one or more of the preceding devices, or the like. Client device 106 may also be any device that is capable of connecting using a wired or wireless communication medium such as a PDA, POCKET PC, wearable computer, and any other device that is equipped to communicate over a wired and/or wireless communication medium to receive and play content. Similarly, client device 106 may employ any of a variety of devices to enjoy such content, including, but not limited to, a computer display system, an audio system, a jukebox, set top box (STB), a television, video display device, or the like.

Client device 106 may include a client that is configured to enable an end-user to receive content and to play the received content. The client may also provide other actions, including, but not limited to, enabling other components of the client device to execute, enable an interface with another component, device, the end-user, or the like.

Client device 106 may receive the content as scrambled/encrypted and employ a conditional access control component to decrypt content, and/or enable revocation of an access entitlement and/or right associated with content. For example, client device 106 may receive content decryption keys, service keys, entitlements and/or rights, or the like. Moreover, client device 106 may employ a smart card, such as a virtual smart card, or the like, to manage access to and decryption of the content.

In one embodiment, client device 106 may further provide an acknowledgement of receipt of an access control message, including an access revocation message, or the like. For example, client device 106 or a component associated with client device 106 may receive a revocation message, revoke the access entitlement/right or license to the content, and in response, further provide an acknowledgement message. In one embodiment, the acknowledgement message may be secured using a variety of mechanisms. Client device 106 may provide the acknowledgement message to CSS 102, or the like, using network 104.

Illustrative Server Environment

FIG. 2 shows one embodiment of a network device, according to one embodiment of the invention. Network device 200 may include many more components than those shown. The components shown, however, are sufficient to disclose an illustrative embodiment for practicing the invention. Network device 200 may, for example, represent CSS 102 of FIG. 1.

Network device 200 includes processing unit 212, video display adapter 214, and a mass memory, all in communication with each other via bus 222. The mass memory generally includes RAM 216, ROM 232, and one or more permanent mass storage devices, such as hard disk drive 228, tape drive, optical drive, and/or floppy disk drive. The mass memory stores operating system 220 for controlling the operation of network device 200. Any general-purpose operating system may be employed. Basic input/output system (“BIOS”) 218 is also provided for controlling the low-level operation of network device 200. As illustrated in FIG. 2, network device 200 also can communicate with the Internet, or some other communications network, via network interface unit 210, which is constructed for use with various communication protocols including the TCP/IP protocol. Network interface unit 210 is sometimes known as a transceiver, transceiving device, network interface card (NIC), or the like.

Network device 200 may also include an SMTP handler application for transmitting and receiving email. Network device 200 may also include an HTTP handler application for receiving and handing HTTP requests, and an HTTPS handler application for handling secure connections. The HTTPS handler application may initiate communication with an external application in a secure fashion.

Network device 200 also may include input/output interface 224 for communicating with external devices, such as a mouse, keyboard, scanner, or other input devices not shown in FIG. 2. Likewise, network device 200 may further include additional mass storage facilities such as CD-ROM/DVD-ROM drive 226 and hard disk drive 228. Hard disk drive 228 is utilized by network device 200 to store, among other things, application programs, databases, or the like.

The mass memory as described above illustrates another type of computer-readable media, namely computer storage media. Computer storage media may include volatile, nonvolatile, removable, and non-removable media implemented in any method or technology for storage of information, such as computer readable instructions, data structures, program modules, or other data. Examples of computer storage media include RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computing device.

The mass memory also stores program code and data. One or more applications 250 are loaded into mass memory and run on operating system 220. Examples of application programs include email programs, schedulers, calendars, transcoders, database programs, word processing programs, spreadsheet programs, and so forth. Mass storage may further include applications such Content Security Manager (CSM) 252, which is configured to manage conditional access to content by a user over a network. CSM 252 may include CAS manager 253, and EMM attack manager (EAM) 254.

CAS manager 253 may be configured to scramble/encrypt content using any of a variety of encryption mechanisms to generate encrypted content, including, but not limited, to RSA algorithms, Data Encryption Standard (DES), International Data Encryption Algorithm (IDEA), Skipjack, RC4, Advanced Encryption Standard (AES), Elliptic Curve Cryptography, or the like.

CAS manager 253 may also selectively encrypt at least a portion of the content leaving another portion unencrypted (e.g., in the clear). CAS manager 253 may selectively encrypt one portion of the content using one encryption technique, and another portion of the content using a different encryption technique. CAS manager 253 may further employ different content encryption keys (CWs) for different portions of the selectively encrypted content.

CAS manager 253 may select to encrypt a video elementary stream (ES), an audio ES, a digital data ES, and/or any combination, and/or any portion of video, audio, data elementary streams to generate encrypted content. CAS manager 253 may further select to encrypt at least a portion of an I-frame, P-frame, B-frame, and/or any combination of P, B, and I frames. Moreover CAS manager 253 may perform such encryption on-the-fly.

CAS manager 253 may also send place CWs into ECMs, and/or service keys within EMMs. CAS manager 253 may also, based on a variety of reasons, insert a revocation of access entitlements/rights of content into an EMM. CAS manager 253 may employ MPEG or another mechanism to prepare and provide the content, ECMs, and/or EMMs to a client device.

It should be noted, however, that the invention is not constrained to using EMMs to revoke an entitlement/right to content. For example, in one embodiment, CAS manager 253 may also employ an Access Control List (ACL) to invalidate access to the content. For example, the ACL may be used to invalidate a digital certificate in a public key infrastructure, or the like, and thereby revoke access to the content.

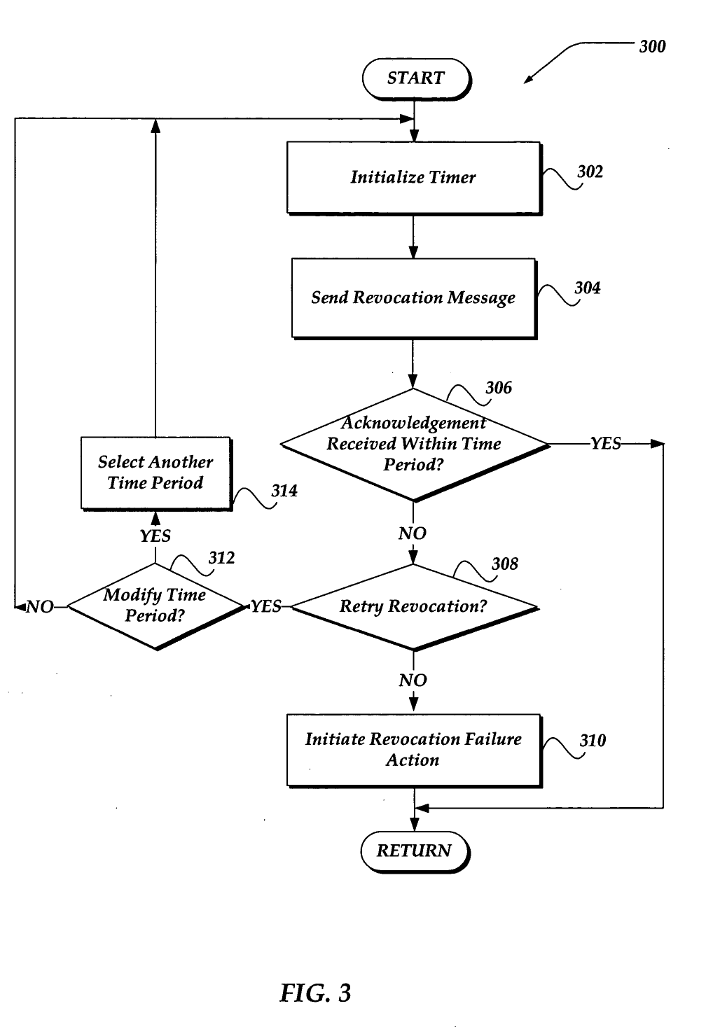

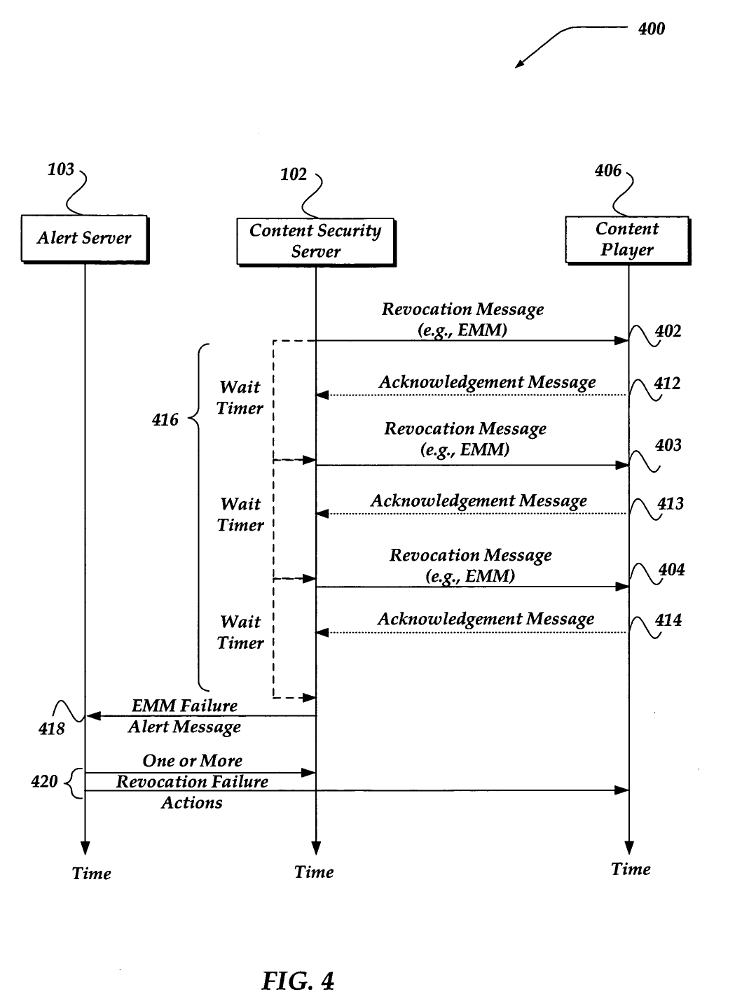

EAM 254 is configured to monitor for an acknowledgement message from a client device based on the revocation message. In one embodiment, the acknowledgment message may be secured using a digital signature associated with client device, subscriber, or the like. In another embodiment, the acknowledgement message may include a nonce, or the like, provided by the client device, CSM 252, or the like, to ensure that the client device is not spoofed, or otherwise hacked. In one embodiment, the nonce may be sent by CSM 252, and then encrypted, digitally signed by the client device, or otherwise modified by the client device to ensure the acknowledgement is from the client device. CSM 252 and its components may employ process 300 of FIG. 3 to perform at least some of its actions.

Generalized Operation

The operation of certain aspects of the invention will now be described with respect to FIG. 3. FIG. 3 shows on embodiment of a data signal flow usable in preventing entitlement/rights filter attacks over a network. Process 300 of FIG. 3 may be implemented within CSS 102 of FIG. 1.

Process 300 is entered when it is determined that a revocation message is to be sent to a client device to revoke an entitlement, right, or license to access content. Thus, process 300 begins, after a start block, at block 302 where a timer may be initialized. The timer may be set to any of a variety of values based a factors, including, but not limited to, a network characteristic, a relationship to a number of retries to be allowed, an urgency, or the like. For example, the time period may be set to a value between about 5 seconds to about 25 seconds. Shorter time periods may be employed, for example, where a network characteristic indicates that acknowledgement messages may be received over a high-speed network link. Longer time periods may be used, for example, where the acknowledgement messages may be received over a low-speed network link, such as a dial-up, or the like. However, the invention is not so limited to this approach, and other characteristics, such as round trip times (RTT), or the like, also may be employed to determine a time period.

In any event, processing flows next to block 304, where the revocation message may be sent to the client device. In one embodiment, the revocation message is provided using an EMM to revoke an entitlement, right, and/or license to access the content. In another embodiment, the revocation message may be an ACL that may be used to invalidate access to the content. For example, in one embodiment, the ACL may invalidate a digital certificate in a Public Key Infrastructure system; provide an invalidation message to a virtual smart card; or the like.

Moreover, it should be clear that while it is illustrated that the timer is initiated prior to sending the revocation message, the invention is not so constrained. For example, the timer may be initiated at substantially the same time the revocation message is sent, or even subsequent to sending the revocation message, without departing from the scope or spirit of the invention.

Process 300 moves next to decision block 306, where a determination is made whether an acknowledgment message is received within the time period. In one embodiment, the acknowledgement message may be encrypted and/or include a nonce, or the like, such that the acknowledgement message may be validated to confirm that it is not hacked, or otherwise spoofed. Thus, part of decision block 306, in one embodiment, may also confirm that the acknowledgement message is valid. If a valid acknowledgement message is received within the time period, processing may the return to a calling process to perform other actions; otherwise, processing may proceed to decision block 308.

At decision block 308 a determination may be made whether to attempt to retry the revocation. In one embodiment, a predetermined number of retry attempts may be performed, the number of which may be based on a variety of factors, including a network characteristic, historical data, or the like. In one embodiment, between about two to about 4 retries may be performed. However, the invention is not limited to such number of retry attempts, and zero, or more, retries may also be performed. In any event, if it is determined that another retry is to be performed, processing branches to decision block 312; otherwise, processing flows to block 310.

At decision block 312, a determination is made whether to modify the time period. For example, in one embodiment, it be determined that a first retry may use one value for the timer's time period, in a second retry, the time period may be increase (or even decreased) by some amount of time. If it is determined that the time period is to be modified, processing flows to block 314, where another time period is selected. Processing the loops back to block 302. If the time period is not to be modified, processing also loops back to block 302, where the timer is initialized based on the selected time period, and then continues as described above, until either a valid acknowledgement is received (decision block 306), or the number of revocation retries is exceeded (in which case, processing flows to block 310).

At block 310, it has been determined that no valid acknowledgement message has been received within the determined number of retry attempts. Therefore, a determined revocation failure action may be performed. Such failure action may include, but is not limited to providing an alert message to direct another system to determine whether a networking failure and/or network device failure has occurred. Such determination may be performed using any of a variety of mechanisms, including, performing a network ping, or similar network analysis action, sending an individual out to investigate the network and/or devices, sending a message to the user associated with the end client device, or the like. In one embodiment, the revocation failure action may include changing one or more encryption keys, service keys, digital certificates, or the like, associated with content to be sent over the network. Process 300 then returns to perform other actions.

FIG. 4 illustrates a message flow diagram generally showing one embodiment of a message flow for preventing entitlement/filter filter attacks in a conditional access to secure content over a network. Message flow 400 of FIG. 4 may include many more or less flows than those shown. The flows shown, however, are sufficient to disclose an illustrative embodiment for practicing the invention. As shown, time is represented as a vertical axis proceeding downwards.

Alert server (AS) 103, content security server (CSS) 102, and content player 406 are represented as providing (and/or receiving) various message flows. Content player 406 may represent a component within client device 106 of FIG. 1, such as a media content player, STB, or the like, that is configured to manage conditional access to content. As such, in one embodiment, content player 406 may receive entitlements/rights and/or licenses to enable access to or revocation of access to content. Moreover, content player 406 may be enabled to provide an acknowledgement message based, at least in part, on receipt of an access (and/or revocation) message.

As shown in FIG. 4, CSS 102 may send a revocation message 402, such as an EMM, or the like, to content player 406 over a network. CSS 102 may then wait for a determined period of time for an acknowledgement message, such as acknowledgement message 412. If acknowledgement message 412 is received, then monitoring is complete, and no further messages for this revocation might be provided. However, if, as described above in conjunction with process 300 of FIG. 3, no acknowledgement is received with the time period, and a retry attempt is to be performed, CSS 102 may then perform one or more retry attempts as illustrated by retries 416 (revocation messages 403-404). If, after the determined number of retries, no valid acknowledgment message is received (acknowledgment messages 413 or 414), then failure alert message 418 may be send by CSS 102 to such as AS 103. In response, AS 103 may perform one or more revocation failure actions 420, as described above. Although not shown, AS 103 may also store failure alert message 418 in a data store. Such storage may then enable AS 103, and/or another device, agency, or the like, to perform a variety of additional actions. Such additional actions, include, but are not limited to performing trend analysis on the stored message(s); enabling possible legal action; determining if the failure is based on an attack, a network issue, or the like; performing analysis to improve network reliability; or the like.

It will be understood that each block of the flowchart illustration, and combinations of blocks in the flowchart illustration, can be implemented by computer program instructions. These program instructions may be provided to a processor to produce a machine, such that the instructions, which execute on the processor, create means for implementing the actions specified in the flowchart block or blocks. The computer program instructions may be executed by a processor to cause a series of operational steps to be performed by the processor to produce a computer implemented process such that the instructions, which execute on the processor to provide steps for implementing the actions specified in the flowchart block or blocks.

Accordingly, blocks of the flowchart illustration support combinations of means for performing the specified actions, combinations of steps for performing the specified actions and program instruction means for performing the specified actions. It will also be understood that each block of the flowchart illustration, and combinations of blocks in the flowchart illustration, can be implemented by special purpose hardware-based systems which perform the specified actions or steps, or combinations of special purpose hardware and computer instructions.

The above specification, examples, and data provide a complete description of the manufacture and use of the composition of the invention. Since many embodiments of the invention can be made without departing from the spirit and scope of the invention, the invention resides in the claims hereinafter appended.

What is claimed as new and desired to be protected Letters Patent of the United States is:

1. A network device for managing access to content over a network, comprising:
a transceiver for receiving and sending information over the network;
a processor in communication with the display and the transceiver; and
a memory in communication with the processor and for use in storing data and machine instructions that causes the processor to perform a plurality of actions, including:
sending a revocation message over the network to revoke access to the content;
if the network device fails to receive a valid acknowledgement message within a time period, then performing at least one retry attempt comprising sending another revocation message; and
if after the at least one retry attempt the network device fails to receive the valid acknowledgement message within at least another time period, performing a revocation failure action.

2. The network device of claim 1, wherein an acknowledgement message is determined to be valid based on at least one of a nonce within the message, or a digital signature.

3. The network device of claim 1, wherein the revocation failure action further comprises performing at least one of changing an encryption/decryption key associated with the secure content, a service key, or performing a network failure detection analysis.

4. The network device of claim 1, wherein the time period and the at least one other time period are different.

5. The network device of claim 1, wherein at least one of the time period or the at least one other time period is based on a network characteristic.

6. The network device of claim 1, the actions further comprising: performing at least two retry attempts.

7. The network device of claim 1, wherein the revocation message further comprises at least one of an Entitlement Management Message (EMM) or an Access Control List (ACL).

8. A system usable in managing access to content, comprising:
a content access component that is operative to perform actions, comprising:
sending a revocation message to revoke access to content;
if the content access component fails to receive a valid acknowledgement message within a time period, then performing at least one retry attempt comprising sending another revocation message; and
if after the at least one retry attempt the content access component fails to receive the valid acknowledgement message within at least another time period, sending a failure alert message; and
an alert component that is operative to perform actions, comprising:
receiving the failure alert message; and
in response, performing at least one revocation failure action.

9. The system of claim 8, wherein the revocation messages and the acknowledgement message are communicated using different mechanisms including at least one of a high-speed network link, a portable content storage device, or a low-speed network link.

10. The system of claim 8, wherein the failure alert message is sent to the alert component using at least one of email message, a Simple Network Management Protocol (SNMP) message, or a Common Management Information Protocol (CMIP) signal

11. The system of claim 8, wherein the actions of the alert component further comprising storing the failure alert message to enable at least one of a trend analysis to be performed, a legal action to be performed, a network failure analysis to be performed, or an analysis to determine if the failure alert message is due to a hacker attack.

12. The system of claim 8, wherein the at least one revocation failure action further comprises analyzing for a network failure between the system and a client device from which the valid acknowledgement message is to be received.

13. The system of claim 8, the at least one revocation failure action further comprises changing at least one access key associated with the content.

14. The system of claim 8, wherein the alert component and the content access component reside within a same network device.

15. The system of claim 8, wherein the content is provided to a client device using MPEG format.

16. The system of claim 8, wherein the revocation message further comprises at least one of an Entitlement Management Message (EMM), or an Access Control List (ACL) that is configured to invalidate a digital certificate.

17. A method usable in managing access to content, comprising:
sending a revocation message to revoke access to the content by a client device;
if a valid acknowledgement message is un-received within a time period, then performing at least one retry attempt comprising sending another revocation message; and
if after the at least one retry attempt the valid acknowledgement message is un-received within at least another time period, performing a revocation failure action.

18. The method of claim 17, wherein the revocation message is prevented from being received by the client device by a filtering mechanism.

19. The method of claim 17, wherein the client device employs a virtual smart card in part to manage access to the content.

20. The method of claim 17, wherein an acknowledgement message is determined to be valid based on at least one of a nonce associated with the message, or a digital signature.

21. The method of claim 17, wherein the revocation failure action further comprises performing at least one of changing an encryption/decryption key associated with the secure content, a service key, or performing a network failure detection analysis.

22. The method of claim 17, wherein the time period and the at least one other time period are different.

23. A modulated data signal configured to include program instructions for performing the method of claim 17.

24. The method of claim 17, wherein sending the revocation message further comprises sending the revocation message using at least one of a network mechanism or a portable content storage device.

25. The method of claim 17, further comprising: sending the content to the client device using at least one of a portable content storage device or a network.

26. An apparatus for managing content encryption over a network, comprising:
a transceiver to receive input data over the network; and
means for sending a revocation message over the network to revoke access to the content;
means for providing at least one revocation retry attempt that includes sending another revocation message, if a valid acknowledgment is un-received within a time period; and
means for performing a revocation failure action based on failure to the valid acknowledgement message within at least another time period.
